(19) United States
(12) Patent Application Publication
(10) Pub. No.: US 2003/0203665 A1
(43) Pub. Date: Oct. 30, 2003

(54) High-frequency electric connector having no ground terminals

(76) Inventors: Koji Ohnishi, Tokyo (JP); Masahiko Matsue, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/421,735

(22) Filed: Apr. 24, 2003

(30) Foreign Application Priority Data
Apr. 26, 2002 (JP) 2002-126010

(51) Int. Cl. H01R 12/00

(52) U.S. Cl. 439/79

(57) ABSTRACT

Disclosed is an improved electric connector comprising an insulating housing having slots arranged crosswise in vertical columns and horizontal lines, and signal terminals received in the slots. The signal terminals are paired to be received in each and every slot. The slots are staggered in vertical columns. The slots are so arranged that the ratio of “a”/“b” may be equal to or smaller than 1/3, where “a” stands for the distance between two signal terminals in each pair, and “b” stands for the distance between adjacent pair sets of signal terminals.

### BACKGROUND OF THE INVENTION

1. Field of the Invention

The present invention relates to an electric connector for use in making a required electric connection between printed circuit boards, between a printed circuit board and a selected device in a computer, or between a printed circuit board and a server or backboard package, and more particularly to an electric connector for use in transmitting high-frequency signals.

2. Related Art

Referring to FIG. 10, a conventional electric connector 11 has a plurality of pair sets of signal terminals 12a and 12b for transmitting high-speed signals in differential transmission way, thereby significantly reducing noise signals. More specifically, if a cross talk appears between the pair of signal terminals 12a and 12b, unwanted signals of same phase can be cancelled. Also, a ground terminal 13 is arranged between adjacent pair sets of signal terminals 12, thereby preventing cross talks from appearing in adjacent pair sets of signal terminals.

Such a conventional electric connector uses extra ground terminals, and accordingly the number of parts to be assembled, and hence, the manufacturing cost will increase. The more the terminal-loading density increases, the narrower the distance between the ground terminal 13 and the signal terminal 12a or 12b of either adjacent pair set decreases, and the larger the signal energy will be lost by the nearby ground terminal 13. Thus, the insertion loss which is caused by inserting the electric connector in the signal-transmitting circuit increases.

The inter-distance “b” between adjacent signal terminals in each pair set decreases, and accordingly the thickness of the signal terminal is reduced. Disadvantageously such thin signal terminals are apt to be deformed or bent in press fitting in selected terminal slots in the connector body.

The signal terminals 12a and 12b of each set are arranged vertically at different levels. Therefore, the upper conductor 12a extending from the upper level to an associated printed circuit board at the lowest level is longer than the lower conductor 12b extending from the lower level to the printed circuit board. As a result the electric signals traveling such different lengths of conductors 12a and 12b reach the printed circuit board at different times, thus causing noises from the electric signals which appear in the pair set of signal terminals 12a and 12b.

One object of the present invention is to provide a high-frequency electric connector which is free of such defects as described above.

### SUMMARY OF THE INVENTION

To attain this object an electric connector comprising an insulating housing having a plurality of slots arranged crosswise in vertical columns and horizontal lines, and a corresponding plurality of signal terminals received in the slots, is improved according to the present invention in that the signal terminals are paired to be received in each and every slot.

With this arrangement a pair of conductors conveying one and same signal are equal in length so that each signal may travel same distance to reach a same place at same time. Thus, the signals traveling the pair set of conductors cause no interference with each other, and no cross talk can be caused. The slots may be staggered in vertical arrangements. The staggered arrangement of pair sets of conductors has the effect of preventing the cross talk from appearing between adjacent pair sets of conductors.

The pair sets of signal terminals have no grounding conductor therebetween, and therefore, the energy of the signal cannot be lost while passing through the connector. Accordingly the high-speed signal transmission characteristics can be improved.

The slots may be so arranged that a/b may be equal to or smaller than ⅓, where “a” stands for the distance between two signal terminals of each pair set, and “b” stands for the distance between adjacent pair sets. This arrangement has the effect of significantly improving the high-speed signal transmission characteristics while minimizing the size of the electric connector with the density of signal terminals per unit area remaining high.

Each pair of signal terminals has their conductors extending parallel to each other, and their parallelism continues to the possible farthest extremities, at which the signal terminals are connected to selected conductors in an associated printed circuit board.

Counter terminals to be mated with each pair of signal terminals are paired, also. Each pair set of counter terminals is parallel arranged at possible minimum interval, and is combined by an intervening insulating member as a whole. The integral joint of two conductors makes them resist to the applied force in press fitting in the slots of the electric connector, preventing them from being bent or deformed to appear short-circuit thereacross.

The parallel, close arrangement of conductors in the electric connector has the effect of increasing the electromagnetic coupling between paired conductors, reducing the loss of signal energy, and improving the high-speed signal transmission characteristics.

Other objects and advantages of the present invention will be understood from the following description of an electric connector according to one preferred embodiment of the present invention, which are shown in accompanying drawings.

### BRIEF DESCRIPTION OF THE DRAWING

FIG. 1 is an exploded perspective view of a multi-column connector according to the present invention;

FIG. 2 is a similar view, illustrating a two-column connector;

FIG. 3 is a side view of the connector;

FIG. 4(A) illustrates how male contact pieces and female contact pieces can be mated, and FIG. 4(B) shows the non-bifurcate end of the female contact piece;

FIG. 5 illustrates how the bifurcate ends of the female contact pieces of each pair are inserted in a selected slot: FIG. 5(A) is a sectional view of a fragment of the rectangular insulating housing; FIG. 5(B) is a sectional view of the fragment taken along the line 5(B)-5(B) in FIG. 5(A); and FIG. 5(C) is a front view of the terminal slot;

FIG. 6 illustrates the female package part of the electric connector: FIG. 6(A) is a front view of the female package; FIG. 6(B) is a sectional view taken along the line 6(B)-6(B) in FIG. 6(A); and FIG. 6(C) is a sectional view taken along the line 6(C)-6(C) in FIG. 6(A);

FIG. 7 illustrates how pair sets of female contact pieces are arranged, and how the lines of electric force are distributed;

FIG. 8 illustrates the male package part of the electric connector: FIG. 8(A) is a front view of the male package; FIG. 8(B) is a side view of the male package; FIG. 8(C) is a bottom view of the male package; and FIG. 8(D) is a sectional view of the male package taken along the line 8(D)-8(D) in FIG. 8(A);

FIG. 9(A) is a plane view of a male contact piece whereas FIG. 9(B) is a front view of the male contact piece;

FIG. 10 is a sectional side view of a conventional electric connector;

FIG. 11 illustrates how pair sets of terminals are arranged in the conventional electric connector, and how the lines of electric force are distributed;

FIG. 12 illustrates how contact pieces are arranged in the conventional electric connector, and how the lines of electric force are distributed; and

FIG. 13(A) shows a printed circuit board in respect of through-holes whereas FIG. 13(B) shows the printed circuit board in respect of how lead wires are connected to through-holes.

### DETAILED DESCRIPTION OF PREFERRED EMBODIMENT

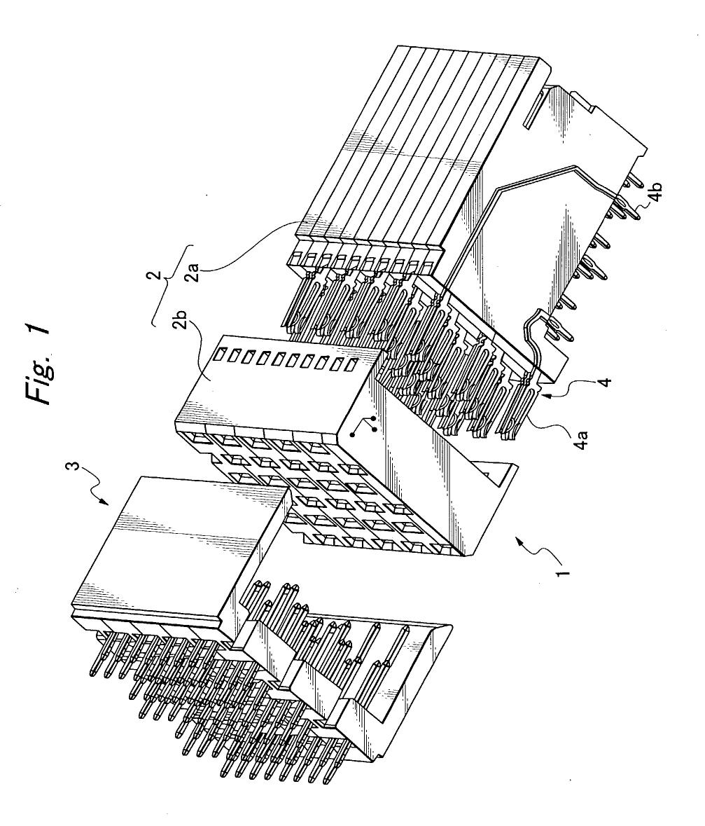

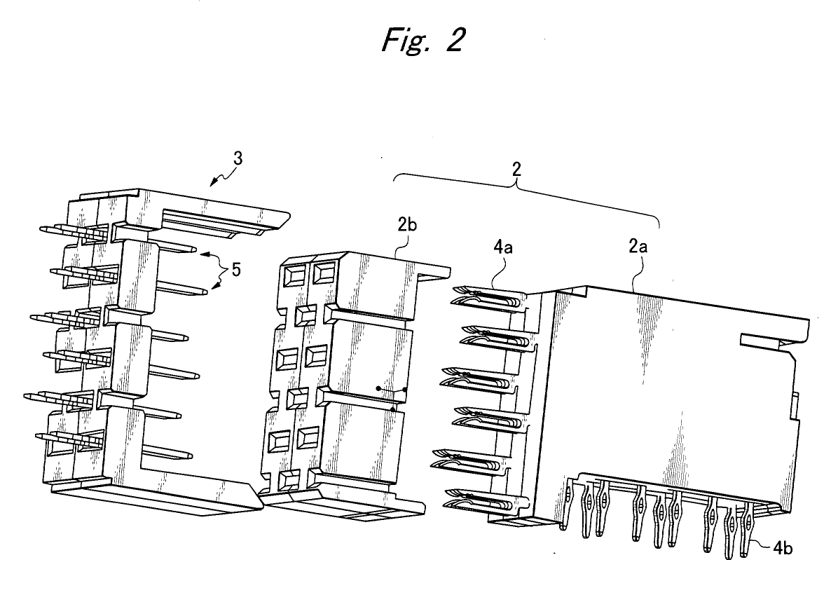

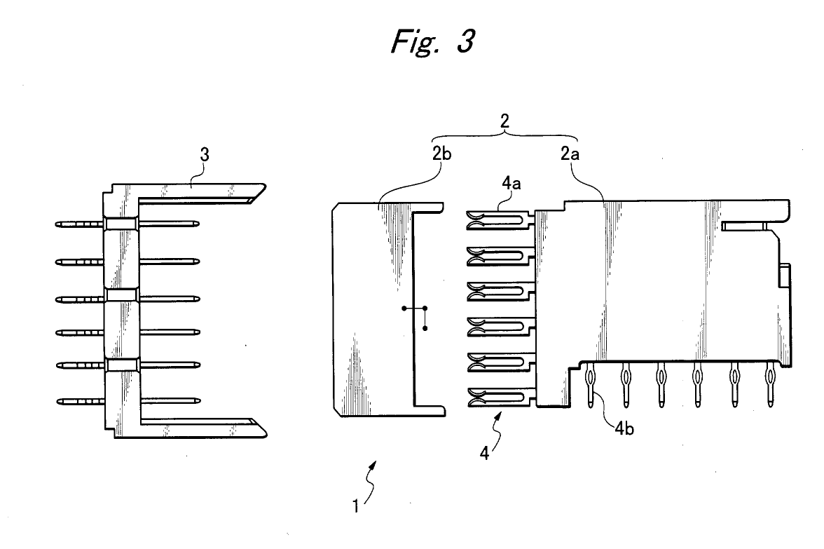

Referring to FIG. 1, an electric connector 1 comprises a female package part 2 and a male package part 3. The female package part 2 comprises a rectangular block 2a and a detachable rectangular insulating housing 2b to be fitted on the front side of the rectangular block 2a. The male package part 3 is a “U”-shaped cover to be applied to the rectangular insulating housing 2b.

The rectangular block 2a has a raised bottom surface to be laid on an associated printed circuit board. The rectangular insulating housing 2b has female slots arranged in the form of lattice. Likewise, the “U”-shaped cover 2b has slots arranged in the same lattice pattern as the rectangular insulating housing 2b.

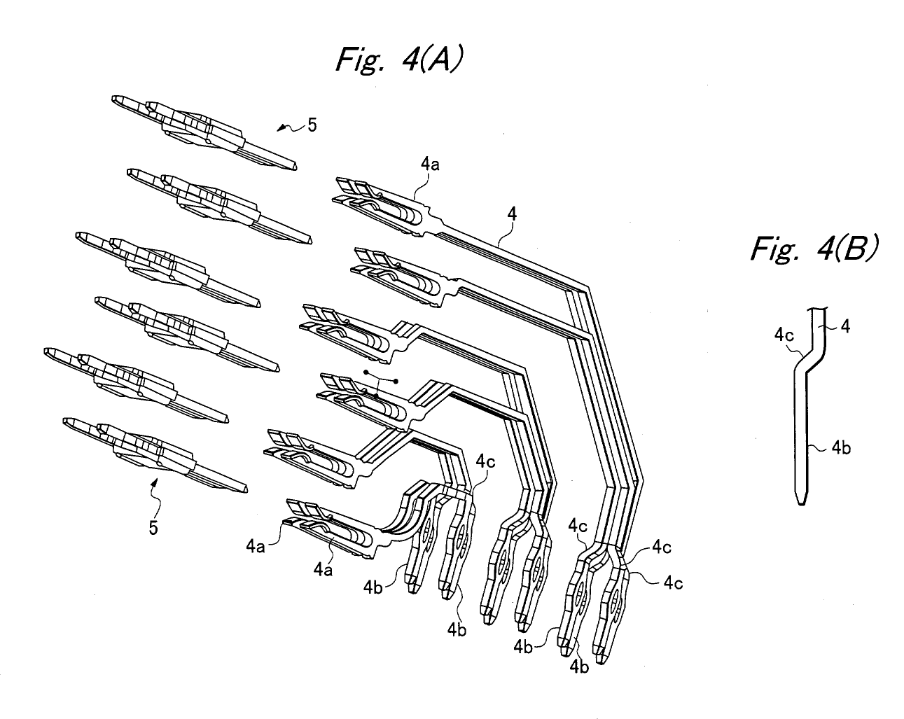

Referring to FIG. 4(A), each female contact piece 4 is composed of a bifurcate contact end 4a, a non-bifurcate contact end 4b directed perpendicular to the bifurcate contact end 4a, and a curved or bent stem integrally connected at its opposite ends both to the bifurcate contact end 4a and non-bifurcate contact end 4b. The stem-to-non-bifurcate-contact-end transient section 4c is bent outward as seen from FIG. 4(B). Thus, pair of parallel-arranged female contact pieces 4 are apart from each other over their non-bifurcate contact ends. A plurality of pair sets of female contact pieces 4 are embedded (or insert-molded) in the rectangular block 2a of the female package part 2 with their bifurcate contact ends 4a appearing on its front side, and with their non-bifurcate contact ends 4b appearing on its raised bottom surface. In this particular example each female contact piece is about 0.4 mm thick, and two female contact pieces 4 are parallel-arranged about 0.4 to 0.5 mm apart from each other. The pair sets of female contact pieces are crosswise arranged in 6 horizontal lines and 6 vertical columns.

The rectangular insulating housing 2b can be applied to the front side of the rectangular block 2a with the bifurcate contact ends 4a inserted in the slots of the rectangular insulating housing 2b.

Referring to FIG. 4, two male contact pieces 5 are combined by an intervening joint to provide a pair set of male contacts as a whole. The male package part 3 has pair sets of male contacts 5 inserted in its slots with their opposite contact extensions appearing on the front and rear sides of the major slotted-plate of the “U”-shaped body 3. When the male package part 3 is applied to the rectangular insulating housing 2b of the female package part 2, the rear contact extensions of the paired male contact pieces 5 are received in the slots of the rectangular insulating housing 2b to mate with the bifurcate contact ends 4a of the female contact pieces 4.

Referring to FIGS. 13(A) and 13(B), the printed circuit board has terminal through-holes 6 made in the lattice pattern. These terminal through-holes 6 are 2 mm apart from each other, and two lead wires 7 are soldered to adjacent through-holes 6 to extend between adjacent through-holes 6, as shown from FIG. 4(B). As described earlier, the bifurcate contact end-plus-stem lengths of each pair of female contact pieces 4 are parallel-arranged to be 0.4 to 0.5 mm apart from each other, and their non-bifurcate contact ends 4b are parallel-arranged to be 2 mm apart from each other, thereby permitting the non-bifurcate contact ends 4b to be inserted into selected adjacent through-holes 6 in the printed circuit board. Thus, the paired female contact pieces 4 can be kept close, and parallel to each other as far as possible, thus minimizing the insertion loss in the electric connector.

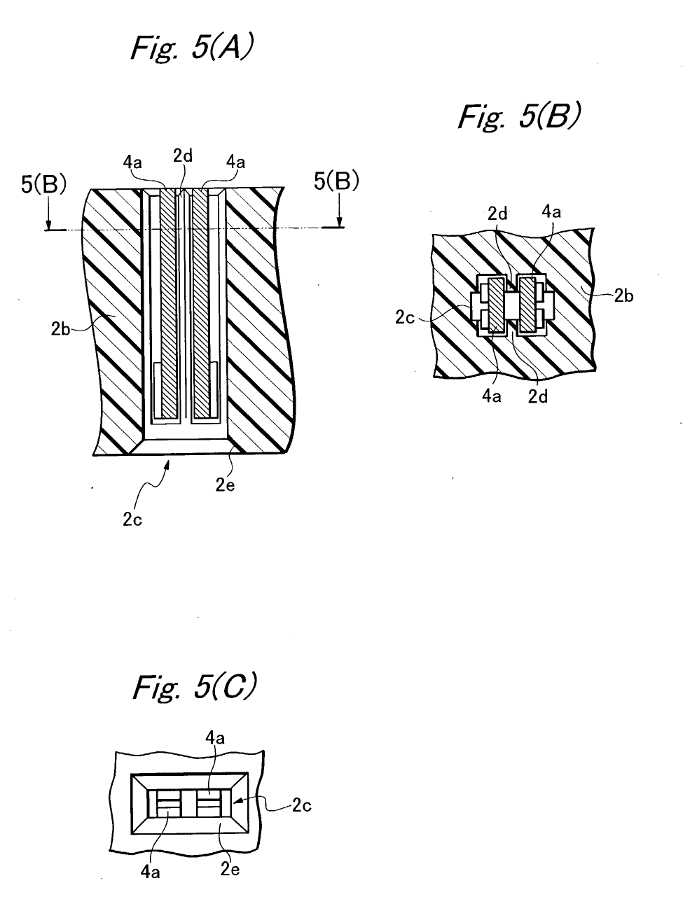

Referring to FIG. 5, each slot 2c of the rectangular insulating housing 2b has a vertical partition 2d formed therein, thereby assuring that the opposite bifurcate contact ends 4a of the paired female contact pieces 4 be electrically isolated from each other. The slot 2c has its four sides 2e chamfered, and its center vertical partition is tapered. Thus, insertion of the paired male contact pieces 5 is facilitated.

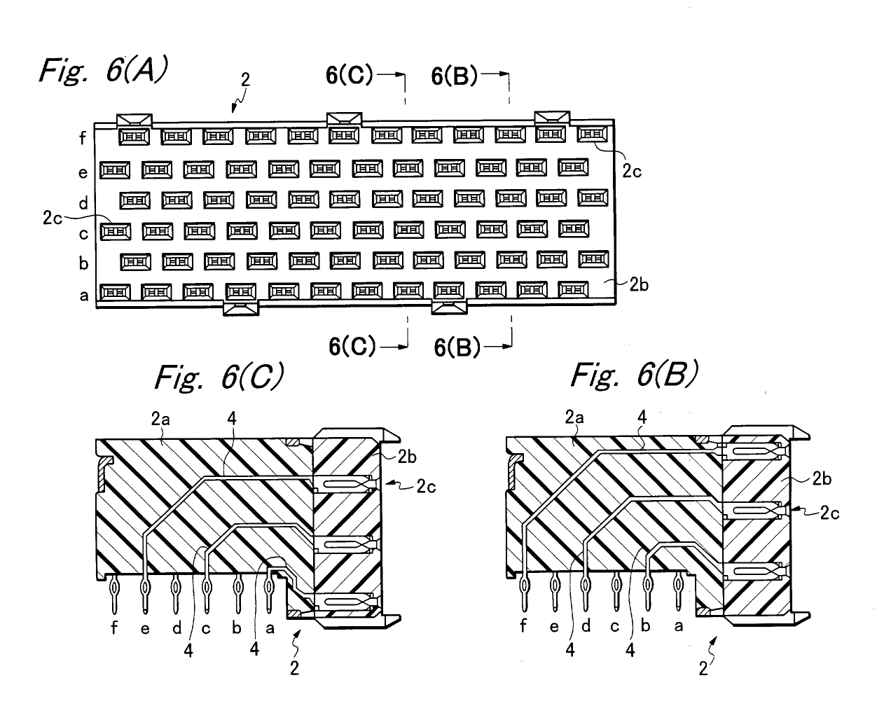

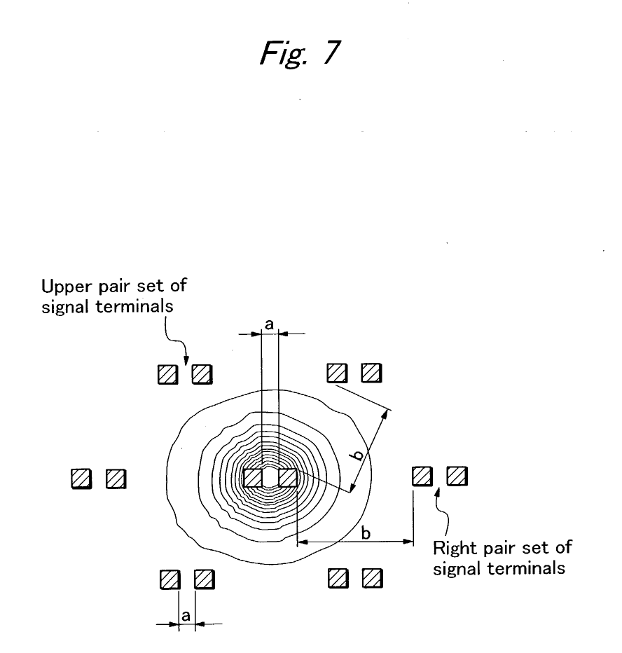

Referring to FIG. 6(A), the female slots 2c are vertically staggered by offsetting half of slot-to-slot distance. Referring to FIG. 7, the female slots 2c are so arranged that the ratio of “a”/“b” may be equal to or smaller than ⅓, where “a” stands for the distance between two female contact pieces 4 in each pair (0.4 to 0.5 mm), and “b” stands for the distance between horizontally- or obliquely-adjacent paired female contact pieces 4. For example, the contact-to-contact distance “a” in the pair is equal to about 0.5 mm, and then, the horizontal distance “b” between horizontally adjacent contact pairs is equal to 1.5 mm. The oblique distance “b” between vertically adjacent contact pairs is equal to 1.6 mm. The longer the distance “b” is, the better the noise-reduction effect is. To meet the desire for increasing the density of contact pieces per unit area of the front of the rectangular insulating housing 2b determination of the ratio of “a”/“b” as being equal to or smaller than ⅓ is a compromise between the significant noise reduction effect and the permissible contact density.

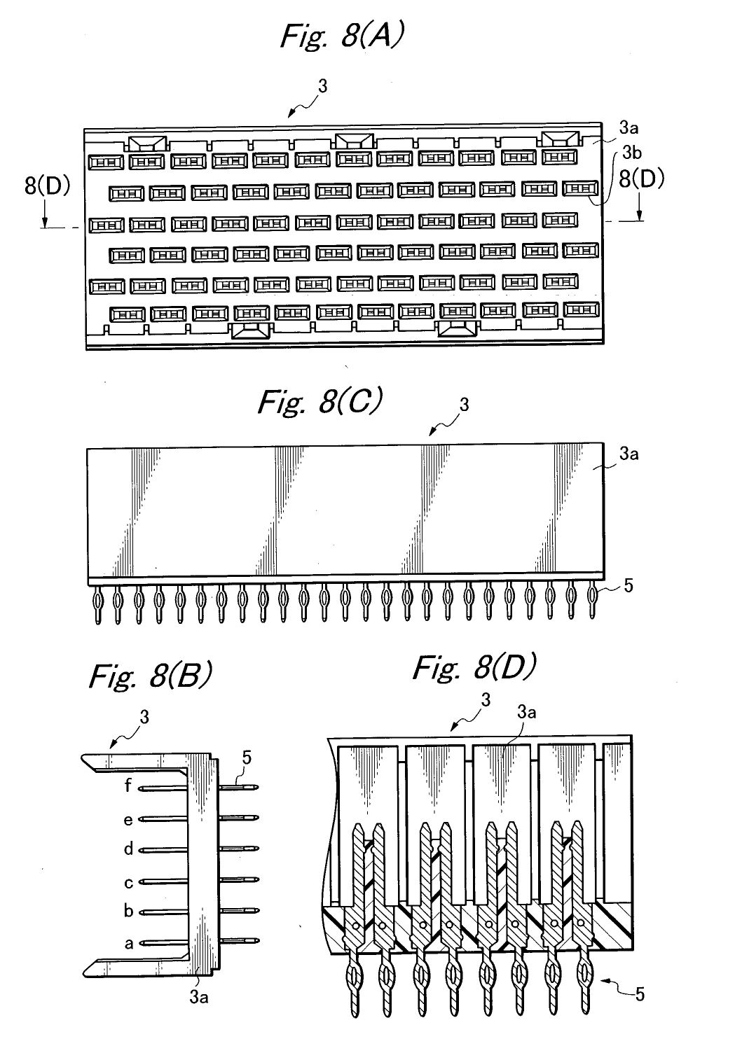

Referring to FIG. 8, the male package part 3 is an insulating housing 3a having male contact pieces 5 press-fitted in its slots 3b.

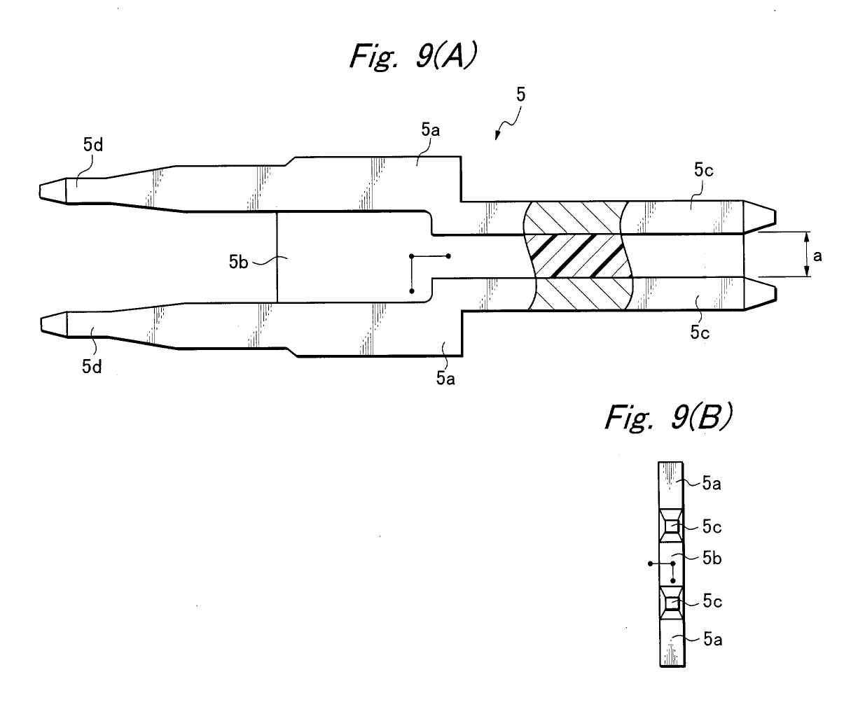

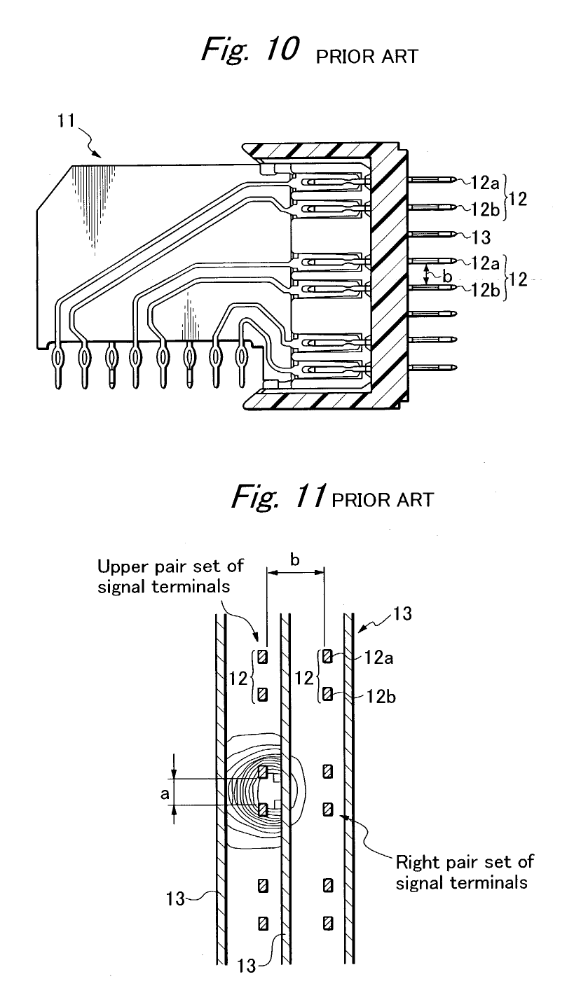

The male contact slots 3b are arranged in the same pattern as the female contact slots 2c in the female package part 2. Referring to FIG. 9, pair of male contact pieces 5a are parallel arranged and integrally connected by filling an insulating resin material 5b therebetween. This assures that the parallel contact pieces 5a be arranged at possible minimum interval, still being kept stable in position. The slots 3b of the male package part 3 are filled with paired sets 5 of male contact pieces 5a.

The rear extensions 5c of the paired male set are apart from each other to be substantially equal to the contact-to-contact distance “a” in the paired set on the female side. The front extensions 5d of the paired male set are apart from each other to be equal to the through-hole-to-through-hole distance in another printed circuit board, and the front extensions 5d of the paired set are arranged in the same lattice pattern as the through-holes in the printed circuit board.

The electric connector 1 according to the present invention provides advantages of significantly reducing the cross talk and the insertion loss as shown in the following Table.

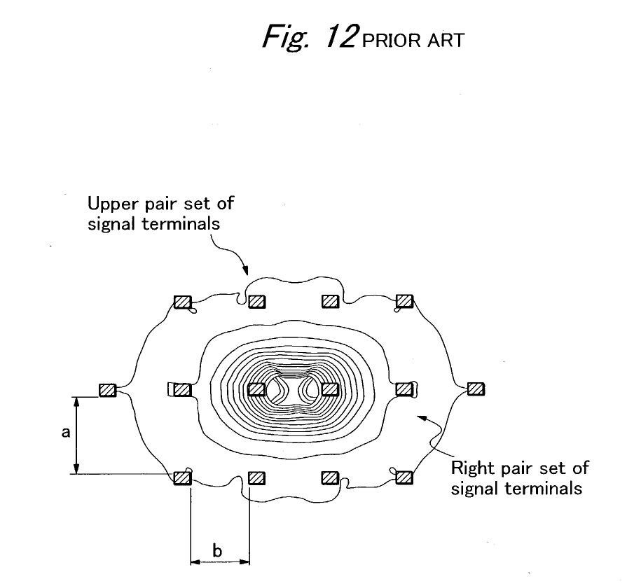

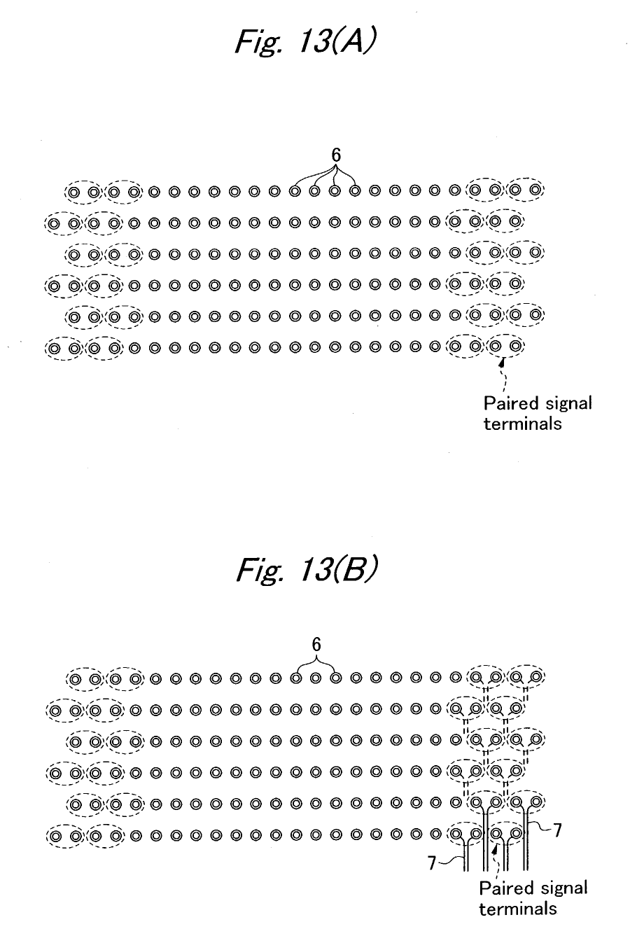

TABLE

| Connector 1 | ratio of “a”/“b” | insertion loss (db) | cross talk % |
|---|---|---|---|
| | | 0.027 (5 GHz) | 0.2 (up side) |
| | 1/3 | 0.286 (20 GHz | 0.6 (right side) |
| Conventional | 1/2.8 | 0.052 (5 GHz) | 0.4 (upper side) |
| Connector: FIG. 11 | | 0.360 (20 GHz) | 0.1 (right side) |
| (high-speed type) | | | |
| Conventional | 1/1 | 0.135 (5 GHz) | 1.7 (upper side) |
| Connector: FIG. 12 | 3.813 (20 GHz) | 3.2 (right side) | |
| (low-, | | | |
| medium-speed | | | |
| type) | | | |

In FIGS. 11 and 12 concentric circles indicate lines of electric forces. The reduction of insertion loss is attributable to use of no grounding terminals or shields. The close parallelism is kept so far to the non-bifurcate end, at which the paired female contact pieces are connected to the printed circuit board. Thus, the signals travel the same length of paired conductors to arrive at the printed circuit board simultaneously, and therefore, the cross talk is minimized even though no grounding terminals are used.

The staggered arrangement of pair sets of contact pieces permits significant increase of the distance “b” between adjacent pair sets, thus permitting the female contact piece 4 to be thick (0.4 mm thick) enough to prevent its non-bifurcate contact ends from being yieldingly bent or deformed when press-fitted in the through-holes in the printed circuit board.

What is claimed is:

1. An electric connector comprising an insulating housing having a plurality of slots arranged crosswise in vertical columns and horizontal lines, and a corresponding plurality of signal terminals received in the slots, wherein the signal terminals are paired to be received in each and every slot.

2. An electric connector according to claim 1, wherein the slots are staggered in vertical columns.

3. An electric connector according to claim 1, wherein the slots are so arranged that the ratio of “a”/“b” may be equal to or smaller than ⅓, where “a” stands for the distance between two signal terminals in each pair, and “b” stands for the distance between adjacent pair sets of signal terminals.

4. An electric connector according to claim 1, wherein each pair of signal terminals has their conductors extending parallel to each other, their parallelism continuing to the possible farthest extremities, at which the signal terminals are connected to selected conductors in an associated printed circuit board.

5. An electric connector according to claim 1, wherein counter terminals to be mated with each pair of signal terminals are paired, and each pair of counter terminals are combined by an intervening insulating member as a whole.
